(19) United States
(12) Patent Application Publication
(10) Pub. No.: US 2015/0248706 A1
(43) Pub. Date: Sep. 3, 2015

(54) Collecting, Synching, and Organizing Data Received from a Single Customer Across Multiple Online and Connected Devices

(71) Applicant: Adara Media Inc., Mountain View, CA (US)

(72) Inventors: Hongcheng Mi, Foster City, CA (US); Ellen M. Lee, Lake Forest, IL (US)

(21) Appl. No.: 14/195,708

(22) Filed: Mar. 3, 2014

(51) Int. Cl. G06Q 30/02; H04L 29/06; G06F 17/30

(52) U.S. Cl. CPC G06Q 30/0269; G06F 17/30091; H04L 67/42; G06Q 30/0255; G06Q 30/0267

(57) ABSTRACT

An advertisement system enables an advertiser to serve a targeted advertisement to a user based on data collected across multiple client devices associated with the same user. The advertisement system correlates client devices to a particular user by collecting, analyzing, and comparing behavioral data, transactional data, and loyalty status data associated with each client device. The advertisement system uses device correlations to serve a targeted advertisement to a user across one or more of the correlated devices.

### BACKGROUND

1. Field of Art

The disclosure generally relates to the field of online advertising and in particular to serving targeted advertisements across multiple devices.

2. Description of the Related Art

Online advertisers generate revenue by serving targeted advertisements to online users. When selecting an advertisement to display to a particular user, online advertisers generally try to determine a demographic that the user belongs to, and serve advertisements that are likely to be of interest to that demographic. Advertisers place a user in a demographic by analyzing the user's activity on a client device, such as a personal computer (PC), tablet, or smartphone. Current methods of tracking user activity, such as cookies or tracking pixels, are specific to the client device they are installed on. However, users increasingly access content on multiple client devices, presenting a challenge to advertisers who cannot coordinate across multiple devices.

### BRIEF DESCRIPTION OF THE FIGURES

Figure (FIG.) 1 is a network diagram illustrating one embodiment of an advertisement system.

FIG. 2 is a modular diagram illustrating an embodiment of a database server.

FIG. 3 is a flow chart illustrating an embodiment of a process for determining an advertisement to serve to a user based on data collected across multiple devices associated with the user.

FIG. 4 is a flow chart illustrating an embodiment of a process for correlating different devices to a particular user based on captured client data.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

An advertisement system enables an advertiser to serve targeted advertisements to a user based on data collected across multiple client devices associated with the same user. The advertisement system correlates client devices to a particular user by analyzing and comparing behavioral data, transactional data, and loyalty status data associated with each client device. The advertisement system uses device correlations to serve targeted advertisements to a user across the correlated devices.

In one embodiment, the advertisement system collects a behavioral data set, a transactional data set, and a loyalty status data set from a first client device and a second client device. The advertisement system correlates data from the first client device with data from the second client device to determine if the client devices meet a similarity threshold. In one method, client data is processed into a set of metrics for each client device using the behavioral, transactional, and loyalty status data sets associated with the client device. The first and the second client devices are correlated when the sets of metrics from each client device meet the similarity threshold, and are subsequently assigned to a set of devices associated with a unique user identifier. Each user identifier is associated with a particular user, although the user's identity may remain anonymous. The advertisement system receives and processes a request to serve an advertisement to the first client device associated with the user identifier and selects a targeted advertisement relevant to the user based on the client data collected across the first and the second client devices associated with the user.

### Example System Architecture

FIG. 1 is a high-level block diagram of a computing environment 100 according to one embodiment. The computing environment 100 comprises one or more web servers 110-1, 110-2, . . . , 110-M (collectively referenced herein as web servers 110), a plurality of client devices 120-1, 120-2, . . . , 120-N (collectively referenced herein as client devices 120), and a database server 140 all connected by a network 150. Only three web servers 110 and three client devices 120 are shown in FIG. 1 for simplicity. Embodiments of the computing environment 100 can have many more web servers 110 and client devices 120 connected to the network 150, as well as multiple database servers 140.

The network 150 represents the communication pathways between the web servers 110, the client devices 120, and the database server 140. In one embodiment, the network 150 includes the Internet, but the network 150 may also include local networks and/or private communications links that are not necessarily part of the Internet. In one embodiment, the network 150 uses standard communications technologies and/or protocols that may include wired and/or wireless interfaces. For example, the network 150 includes communication links using technologies such as Ethernet, 802.11, worldwide interoperability for microwave access (WiMAX), 3G, 4G, Long Term Evolution (LTE), code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 150 may be encrypted using any suitable technique or techniques.

In one embodiment, the web servers 110 host web sites or other web-based content. The web servers 110 provide web content to a requesting client 120 and may also collect various data from a connected client 120. For example, web servers 110 may keep records of which clients 120 have accessed the web server 110, transactions executed by a client via the web server 110, or profile information associated with a particular client 120 obtained by the web server 110. The web server 110 may also communicate information to and from the database server 140. For example, the web server 110 may request advertisements from the database server 140 to serve together with the web content. Furthermore, the web server 110 may provide information to the database server 140 collected from the client devices 120 to enable the database server 140 to select advertisements that target a user based on the collected data.

The client device 120 comprises computing device, such as a laptop, a desktop, a tablet, a smartphone, or other network-enabled device. Each client device 120 is typically operated by a user to perform various activities including interacting with websites, social networks, or online applications hosted by one or more web servers 110. The client device 120 may execute a browser application that enables the client to access and display websites hosted by a web server 110. Furthermore, cookies may be installed on the client device 120 to track device activity in the browser application. The cookies may be exchanged between the client device 120 and the web servers 110, the database server 140, or both. Other applications besides web browsers (e.g., mobile applications) may similarly access web content from the web servers 110 and provide various information to the web servers 110, the database server 140, or both regarding the user's activity on the client device 120.

The database server 140 receives data about the client devices 120 either directly from the client devices 120 or from the web servers 110. The database server 140 correlates the data from multiple different client devices 120 to determine which devices are likely associated with the same users, analyzes the data across the multiple devices linked to the same users, and generates advertisements targeted to specific users based on the data analysis. In one embodiment, the database server 140 generates a set of metrics for each client device 120 based on the collected data and compares the sets of metrics to match client devices that are likely to be associated with the same user. Furthermore, the database server 140 receives and processes requests to serve targeted advertisements to specific clients 120. By grouping clients together that are likely to be associated with the same user, the database server 140 is beneficially able to obtain a more complete picture of the user because it can analyze the user's behavior across different devices. This enables the database server 140 to better target advertisements to the user.

A simple example of a benefit of this system 100 is described as follows. A particular user is a frequent guest of a particular hotel chain and has booked multiple reservations for hotels in various locations over the past several months using his laptop computer. While the user's specific identity remains anonymous for privacy purposes, the web server 110 that facilitates the reservation can track that multiple reservations were made using the laptop and provide this information to the database server 140. Separately, the user books a flight to Calgary on his mobile device. In a conventional advertisement system, each client device is treated independently, and the system would not know that the user booking the flight was the same as the user making the hotel reservations. However, by analyzing and correlating other behavioral data, gathered from browsing activity, from the two devices, the database server 140 can determine that the user is the same. The database server 140 can then use the information collectively obtained from the two different client devices 120 to target an advertisement to the user on one of the client devices 120. For example, the database server 140 can provide an advertisement for a hotel room at the Calgary location of the hotel chain where the user frequently stays, and furthermore this advertisement can be provided via either the laptop, the mobile device, or both. Other example scenarios illustrating the benefit of the described embodiments will be apparent to those of ordinary skill in the art.

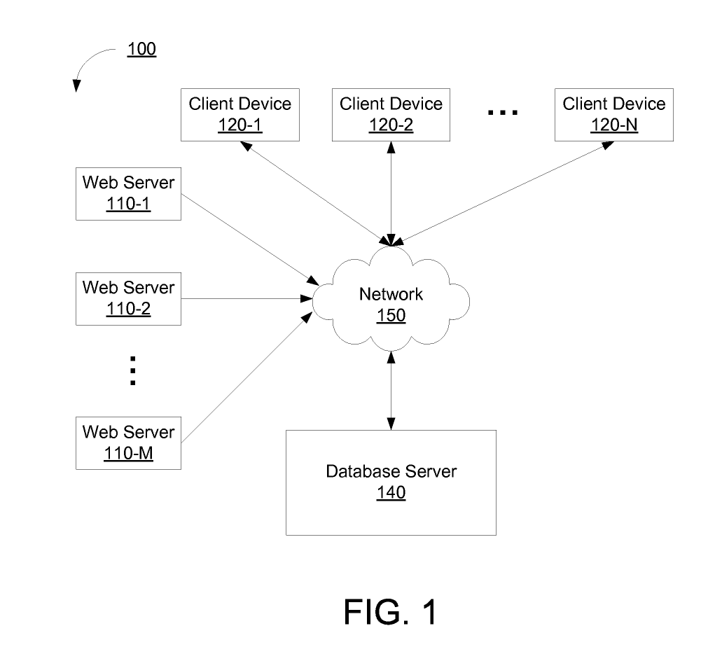

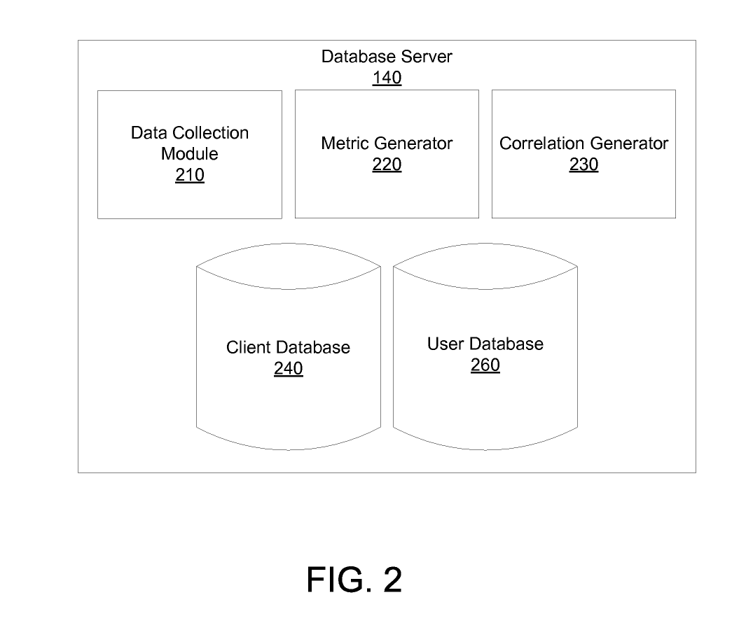

FIG. 2 is a modular diagram illustrating an example embodiment of a database server 140. In the illustrated embodiment, the database server 140 comprises a data collection module 210, a metric generator 220, and a correlation generator 230. Additionally, the database server 140 comprises a client database 240 and a user database 260. In other embodiments, the database server 140 may include additional, fewer, or different modules for various applications.

The data collection module 210 receives client data pertaining to client device 120 via the network 150. Client data may refer to any web, browsing, or application activity on the client device 120 or user information (e.g., profile information) associated with the user of the client device or activity on the client device iteself. This data may be obtained directly from the client device 120, from web servers 110, or from external databases. The data collection module 210 stores the client data to the client database 240. Furthermore, the data collection module 210 stores an identifier, such as an internet protocol (IP) address, associated with the client device 120 together with the corresponding data.

In one embodiment, client data comprises: (1) behavioral data, (2) transactional data, or (3) loyalty status data. Behavioral data comprises information describing activity on a specific client device 120. Behavioral data may include, for example, a web browsing history associated with the client device 120, a set of search terms entered into a search engine, a timeframe associated with a website access, a default language used on the client device 120, a set of advertisements viewed on the client device 120, mobile applications accessed by the client device, or other activities of the client device 120.

Transactional data comprises information describing web-based transactions performed using the client device 120. Transactional data may include, for example, a history of purchases made on a client device 120 including information such as the product vendor, the specific product purchased, timing of the purchase, amount of the purchase; a history of reservations made on a client device 120 including information identifying a hotel, airline, restaurant, etc. associated with the reservation, an amount of the transaction, timing of the transaction, or locations associated with the transaction.

Loyalty status data comprises information related to loyalty programs associated with the client device 120. In this context, a loyalty program is a program or club associated with a company, consortium of companies, or brand that typically rewards members for continued patronage. Examples of loyalty programs include frequent-flyer programs for airlines, rewards cards for grocery stores, and valued guest programs for hotels. Embodiments of loyalty status data include a set of loyalty program usernames or identification numbers used on the client device 120, a set of loyalty program websites accessed by the client device 120, or a set of purchases made with a on the client device 120 using a loyalty program. While loyalty status data may be collected from loyalty program profiles, loyalty status data may be additionally or alternatively collected from web activity or browsing history.

The specific types of behavioral data, transactional data, and loyalty data discussed herein is exemplary and in various embodiments, the types of information used may be limited to protect privacy concerns of the users. Furthermore, in one embodiment, users may be given the option to opt out of sharing all or particular types of behavioral data, transactional data, and loyalty data.

The metric generator 220 generates a set of metrics for each client device 120 based on the client data received from the client devices 120. The metrics generator 220 processes raw client data associated with a specific client device 120 into a set of metrics, also associated with the same client device 120. In one form, the metrics generator 220 may process the raw client data using a natural language classifier, a computer-based neural network, or another type of machine learning algorithm. For example, the metrics generator 220 processes a browsing history on a client device 120 to extract a “most frequently visited website” metric by ranking how frequently each website in the browsing history was accessed by the client device 120. In another example, the metrics generator 220 generates a metric indicating a loyalty program associated with the client device 120 by parsing a set of loyalty program login events collected by the data collection module 210. Other examples of metrics created by the metric generator 220 include a last purchase made on the client device 120, a timeframe associated with a specific loyalty program membership, and a set of usernames accessed on the client device 120. However, many other metrics may be generated from the client data as will be apparent to those of ordinary skill in the art. Additionally, metrics may comprise information that does not fall into the category of client data but may further identify the client device 120. For example, these metrics include a set of programs installed on the client device or a physical location associated with the client device. Furthermore, metrics may be specific to a type of client device 120. A phone number associated with a client smartphone may be used as a mobile device metric, but the phone number metric may not be applicable to a client laptop. The set of metrics for each client device 120 may be stored in a hash, or a string of variables, associated with the device 120.

A correlation generator 230 determines a similarity measure between client data associated with the two or more devices and groups devices based on the similarity measures. The similarity measure is a measure of the likelihood that client data associated with a first client device 120 is similar to corresponding client data associated with a second client device 120. In one embodiment, the correlation generator 230 correlates client data by comparing the sets of metrics associated with each client device derived from the respective client data. In one embodiment, the correlation generator 230 compiles each set of metrics determined from the data for a client device 120 into a metrics vector associated with that specific client device 120. The correlation generator 230 compares a metrics vector associated with one client device 120 to at least one other metrics vectors associated with other client devices 120 in the database server 140. The correlation generator 230 generates a similarity measure for each metric in the metrics vectors. The similarity measure may be, for example, a correlation coefficient, a confidence interval, a distance between two points, or any other measure of similarity apparent to a person having ordinary skill in the art. Furthermore, the correlation generator 230 may assign weights to individual similarity measures, such that these similarity measures are given more consideration in determining whether two client devices 120 are associated with the same user. The correlation generator 230 may furthermore generate an overall similarity measure based on the individual similarity measures for each metric. Based on the overall similarity measure, the correlation generator 230 groups client devices 120 into a set of client devices 120 that meet a predefined similarity threshold and are therefore likely associated with the same user. For example, the correlation generator 230 may use a minimum similarity measure threshold, a weighted average of similarity measures, a regression model, a machine learning algorithm, or another form of mathematical analysis to make this determination.

The set of client devices 120 grouped by the correlation generator 230 is stored in a user database 260. In one embodiment, information identifying each client device 120 in the set of client devices (e.g., an IP address) is stored in the user database 260. Furthermore, each client device 120 in the set of client devices is assigned a user identifier, which associates the client device 120 with a specific user. Each client device 120 in the set of client devices attributed to the same user, as determined by the correlation generator 230, is assigned the same user identifier corresponding to the same user. The user identifiers are also stored in the user database 260. Client data retrieved from client devices 120 associated with a user identifier is attributed to the user associated with the user identifier. This allows the system to retrieve a variety of information (e.g., client data and/or client metrics) about a single, specific user from multiple client devices 120 associated with the specific's user identifier. The retrieved information can be aggregated or analyzed separately.

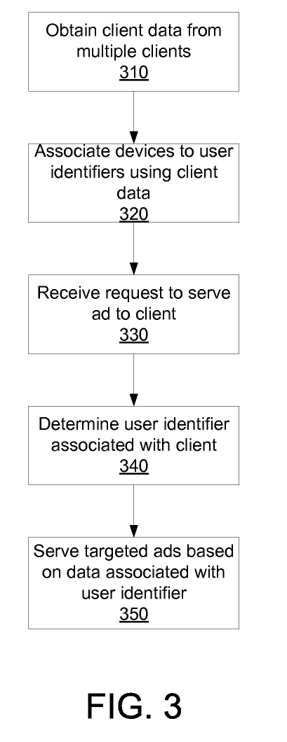

FIG. 3 is a flowchart illustrating an embodiment of a process for serving targeted advertisements to correlated devices. In one embodiment, the process of FIG. 3 is enabled by a software application executing on the database server 140. For example, the database server 140 may comprise computer-executable instructions stored to a non-transitory computer-readable storage medium that when executed by a processer causes the processor to perform the steps of FIG. 3 below.

The database server 140 receives 310 client data from each of a plurality of client devices. The client data from each client device 120 comprises a set of behavioral data, a set of transactional data, and a set of loyalty status data. In one embodiment, client data is received directly from the client device 120. In another embodiment, the database server 140 receives client data from a web server 110 that the client device 120 accessed or from an external database that aggregates client data.

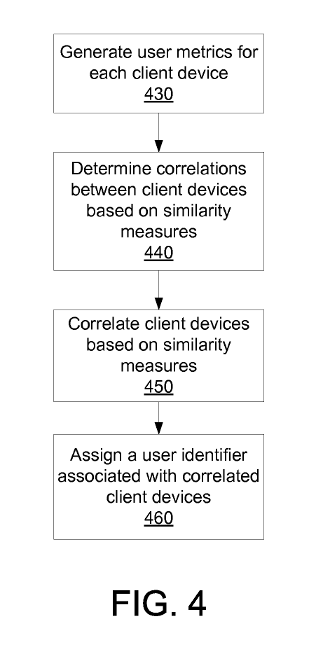

The database server 140 associates 320 client devices to a common user identifier based on analysis of the client data. Client devices are organized into sets of devices, in which client devices determined to be associated with the same user are grouped in the same set. This step is further explained in FIG. 4, which illustrates an embodiment of a process for correlating client devices 120 and assigning client devices 120 to device sets.

The database server 140 receives 330 a request from a web server 110 to serve an advertisement to a client device 120.

The database server 140 determines 340 which user identifier is associated with the ad request. For example, when the web server 110 sends a request to serve an advertisement to a client device 120, the database server 140 determines an internet protocol (IP) address associated with the client device 120 and retrieves the user identifier associated with the IP address. In one embodiment, the database server also retrieves information associated with the user identifier, such as client data associated with the client device 120, other devices linked to the requesting client, a set of metrics associated with the device 120, or other devices grouped with the requesting client device 120. This additional information may be used as targeting criteria for serving targeted advertisements to the client devices 120 in the device set.

The database server 140 fulfills 350 an ad request to a specific client device 120 based on the associated user identifier. The ad request may be fulfilled by serving an advertisement to a web server 110 being accessed by the client device, directly to the client device 120, or to another client device 120 associated with the same user identifier. In another embodiment, the database server instead provides client device information, such as the user identifier, a set of client devices associated with the user identifier, or a set of metrics associated with the user identifier, to a web server 110. The web server 110 then uses the information to serve an advertisement to the client device 120 associated with the information.

FIG. 4 is a flowchart illustrating an embodiment of a process for correlating devices to a particular user. In one embodiment, the process of FIG. 4 is enabled at least in part by an application executing on the database server 140. For example, the application may comprise computer-executable instructions stored to a non-transitory computer-readable storage medium that when executed by a processer causes the processor to perform the steps of FIG. 4 below.

The database server 140 correlates client devices to a particular user by comparing client data associated with each client device 120. Client devices 120 with similar client data (e.g., similar web activity, similar browsing history, etc.) are attributed to the same user. In one example embodiment, client devices 120 may be correlated by directly comparing client data from each client device 120. Client devices 120 with similar client data assigned to the same group. The group is then associated with a single user. In another example embodiment, client devices 120 are correlated by comparing a set of metrics derived from the client data associated with each client device 120. In this process, the database server 140 generates 430 a set of metrics for each client device 120 based on the client data associated with each device received by the database server 140. The set of metrics for each client device 120 may be based in part on behavioral data, transactional data, and/or loyalty status data. Alternatively, one or more metrics may be based on identifying information of the client device 120. In one example embodiment, client data from each client device 120 is processed by the server 140 into a predetermined set of metrics or predetermined categories of metrics.

The database server 140 determines 440 correlations between two or more devices based on similarities between the data associated with each device For example, the database server 140 determines 440 a correlation between two client devices 120 by comparing each metric shared between the two client devices 120. Each metric shared between the two devices 120 is assigned a similarity measure, which indicates the similarity of the respective metric on the two client devices 120. The similarity measures for each metric may be aggregated into an overall similarity metric, which describes the overall similarity of client data on each client device 120. Based on the overall similarity measure, the client devices are grouped into sets of devices, wherein each client device 120 in the set of devices is attributed to the same user and the set may comprise any number of client devices 120.

The database server 140 correlates 450 client devices 120 into device sets. Client devices 120 may be associated with each other based in part on the similarity measures assigned to that set of client devices. For example, a device 120 may be assigned to a device set corresponding to a common user when each similarity measure in a set of similarity measures or an overall similarity measure passes a minimum similarity measure threshold. The database server 140 assigns 460 a user identifier to each device set in the server 140, corresponding to a common user associated with each of the devices.

### Additional Configuration Considerations

One example embodiment of the system and method above beneficially associates multiple distinct client devices 120 with a single user. A client device 120 may have limited or incomplete client data regarding a user of the client device, wherein incomplete client data may limit the variety of advertisements served to the client device. Furthermore, the user may use other client devices 120 which similarly lack a complete set of client data. The server 140 correlates client devices 120 by analyzing the web activity on each client device and associates client devices with similar web activity to a single user. By associating multiple client devices 120 to a single user, the server 140 obtains more information about a user of the multiple client devices. This additional information beneficially allows the server 140 a wider variety of information with which to base targeted advertisements on. Also, the server 140 can serve targeted advertisements across multiple client devices 120 associated with the user, increasing the user's exposure to targeted advertisements.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, which by way of example are executable by web servers 110, client devices 120, and database servers 140 as described above. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules and can be stored as instructions in a memory or other storage.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for serving targeted advertisements across multiple devices through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope.

What is claimed is:

1. A method for serving a targeted advertisement to a first client device, comprising:
obtaining first client data associated with the first client device, the first client data comprising (1) a behavioral data set representing captured web activity of the first client device, (2) a transactional data set representing a captured web transaction performed using the first client device, and (3) a loyalty status data set representing a brand loyalty membership associated with a user of the first client device;
generating a first set of metrics for the first client device based on the first client data associated with the first client device;
obtaining second client data associated with a second client device;
generating a second set of metrics for the second client device based on the second client data associated with the second client device;
generating, by a computing system, a similarity measure indicating a similarity between the first set of metrics associated with the first client device and the second set of metrics associated with the second client device;
grouping the first client device and the second client device into a set of client devices based on the similarity measure exceeding a similarity threshold;
assigning a user identifier to the set of client devices;
receiving a request to serve an advertisement to the first client device;
selecting an advertisement targeted to the first client device based on the client data associated with the first client device and client data associated with the second client device; and
serving the selected advertisement to the first client device.

2. The method of claim 1, wherein the first client device comprises a personal computer and wherein the second client device comprises a mobile device, the first and second client devices associated with the same user.

3. A method for serving a targeted advertisement to a first client device, comprising:
obtaining first client data associated with the first client device, the first client data representing user activity on the first client device;
obtaining second client data associated with a second client device, the second client data representing user activity on the second client device;
correlating the first client data associated with the first client device with the second client data associated with the second client device to determine if the first and second client data meet a similarity threshold;
responsive to the first and second client data meeting the similarity threshold, storing an association between the first and second client data;
receiving a request to serve an advertisement to the first client device;
selecting an advertisement targeted to the first client device based on the first client data associated with the first client device and the second client data associated with the second client device; and
serving the selected advertisement to the first client device.

4. The method of claim 3, wherein correlating the first client data associated with the first client device with the second client data associated with the second client device comprises:
generating a first set of metrics for the first client device based on the first client data associated with the first client device;
generating a second set of metrics for the second client device based on the second client data associated with the second client device; and
correlating the first client data and the second client data based on the first and second sets of metrics.

5. The method of claim 4, wherein correlating the first client data and the second client data based on the first and second set of metrics comprises:
determining a distance measure between each metric of the first set of metrics and a corresponding metric associated with the second set of metrics; and
determining an overall similarity measure based on the distance measures.

6. The method of claim 3, wherein the first client data comprises a behavioral data set, a transactional data set, and a loyalty status data set.

7. The method of claim 6, wherein the behavioral data set comprises data that represents user activity on the first client device.

8. The method of claim 6, wherein the transactional data set comprises data that represents a captured web transaction performed using the first client device.

9. The method of claim 6, wherein the loyalty status data set comprises data representing a brand loyalty membership in a loyalty program associated with the user of the first client device.

10. The method of claim 4, wherein correlating the first client data and the second client data based on the first and second set of metrics comprises determining a similarity measure between the first and second set of metrics.

11. The method of claim 10, wherein the similarity measure represents a likelihood that the first client device and the second client device are associated with the same user.

12. A non-transitory computer-readable storage medium storing instructions for serving a targeted advertisement to a first client device, the instructions, when executed by a processor, cause the processor to:
obtain first client data associated with the first client device, the first client data representing user activity on the first client device;
obtain second client data associated with a second client device, the second client data representing user activity on the second client device;
correlate the first client data associated with the first client device with the second client data associated with the second client device to determine if the first and second client data meet a similarity threshold;
responsive to the first and second client data meeting the similarity threshold, store an association between the first and second client data;
receive a request to serve an advertisement to the first client device;
select an advertisement targeted to the first client device based on the first client data associated with the first client device and the second client data associated with the second client device; and
serve the selected advertisement to the first client device.

13. The computer-readable storage medium of claim 12, wherein correlating the first client data associated with the first client device with the second client data associated with the second client device comprises:
generating a first set of metrics for the first client device based on the first client data associated with the first client device;
generating a second set of metrics for the second client device based on the second client data associated with the second client device; and
correlating the first client data and the second client data based on the first and second sets of metrics.

14. The computer-readable storage medium of claim 13, wherein correlating the first client data and the second client data based on the first and second set of metrics comprises:
determining a distance measure between each metric of the first set of metrics and a corresponding metric associated with the second set of metrics; and
determining an overall similarity measure based on the distance measures.

15. The computer-readable storage medium of claim 12, wherein the first client data comprises a behavioral data set, a transactional data set, and a loyalty status data set.

16. The computer-readable storage medium of claim 15, wherein the behavioral data set comprises data that represents user activity on the first client device.

17. The computer-readable storage medium of claim 15, wherein the transactional data set comprises data that represents a captured web transaction performed using the first client device.

18. The computer-readable storage medium of claim 15, wherein the loyalty status data set comprises data representing a brand loyalty membership in a loyalty program associated with the user of the first client device.

19. The computer-readable storage medium of claim 13, wherein correlating the first client data and the second client data based on the first and second set of metrics comprises determining a similarity measure between the first and second set of metrics.

20. The computer-readable storage medium of claim 19, wherein the similarity measure represents a likelihood that the first client device and the second client device are associated with the same user.
